(19) United States
(12) Patent Application Publication
(10) Pub. No.: US 2009/0039081 A1
(43) Pub. Date: Feb. 12, 2009

(54) Step can

(75) Inventors: Tucker H. Fort, New York, NY (US); Jonathan Cedar, New York, NY (US); Juan Carlos Escobar, New York, NY (US)

Correspondence Address: SEYFARTH SHAW LLP, 131 S. DEARBORN ST., SUITE 2400, CHICAGO, IL, 60603-5803, US

(73) Assignee: Helen of Troy Limited

(21) Appl. No.: 11/891,238

(22) Filed: Aug. 9, 2007

(51) Int. Cl. B65F 1/08; B65F 1/14; B65F 1/16

(52) U.S. Cl. 220/23.87; 220/604

(57) ABSTRACT

A trash can is disclosed having an exterior shell, a liner seated within the shell, a latch pivotably attached to the liner for securing a flexible bag to the liner, and a handle to facilitate placing and removing of the liner from the shell. An optional aspect of the invention is to affix the handle of the liner to the latch. The liner of the trash can, in a featured embodiment, utilizes a latch having a body portion into which surplus of the flexible bag may be gathered and held. The trash can may further include a lid connected to the exterior shell. The lid connects to the shell using a front hinge and a back hinge and is actuated by a foot pedal. The actuating foot pedal is preferably seated at a base of the exterior shell and connects to the lever arm of the front hinge such that depressing the foot pedal exerts a downward force on the lever arm to open the lid. In this configuration, the lid is lifted via a downward pull on the first hinge rather than a direct upward force on the lid.

### TECHNICAL FIELD OF THE INVENTION

The present invention relates to a step can for a bathroom or other such area. Particularly, the present invention relates to a step can having a removable liner and designed to abut a wall or the like.

### BACKGROUND OF THE INVENTION

Receptacles, such as waste disposal containers, having foot operated mechanisms that allow “hands free” opening of the receptacle's lid, are well known in the art. Such a receptacle is most commonly referred to as a “step can.” A simple embodiment of a step can has a foot pedal linked to a generally vertical bar, which, in turn, is linked to an end of the can's lid. When the foot pedal is depressed, the vertical bar is pulled downward, lowering an end of the lid, and thereby opening the receptacle. A slightly more complex linkage mechanism allows more convenient frontal activation of the foot operated mechanism without interference by the vertical bar that lifts the lid. The latter embodiment has a generally horizontal bar (on which the foot pedal is located) pivotally linked to a first end of a generally vertical bar. The vertical bar is, in turn, pivotally linked at its second end to an end of the lid of the receptacle. The lid is hinged to the receptacle radially outwardly from the pivotal link with the vertical bar such that when the horizontal bar is depressed, the vertical bar is raised and the lid is tilted open. Typically, in the either case, the lid swings open to invariably bang against an adjacent surface to which the can was too closely placed.

Further, placing and removing a flexible bag to and from such receptacles can be a daunting task. Outer shells often lift over enclosed liners or a flexible bag can be retracted and replaced through the open top of the can.

The above-described foot operated containers are particularly useful in the home, office, public restrooms and the like in which manual operation of an unsanitary container is undesirable. The convenience of easily stepping on a pedal to open a container, while one's hands may be occupied or needed for holding the object to be disposed also makes such containers popular and rather common in these facilities.

Nonetheless, the simplicity of foot-operated containers may be a disadvantage where the continuous clang of the lid against an adjacent surface is both distracting and destructive. Even when placed a distance from adjacent objects, subsequent use of the can often pushes the can backward until it meets with an object or surface. Also, the convenience and cleanliness of the hands-free feature may be lost somewhat when it comes time to replacing the disposable bag.

It therefore would be desirable to provide a step can which maintains a suitable distance from adjacent objects and surfaces at placement and during use. It also would be desirable to provide a step can which provides easy access to removing and replacing the flexible disposable bag without mess or hassle.

### SUMMARY OF THE INVENTION

There is disclosed herein an improved step can for a bathroom or the like, which avoids the disadvantages of prior devices while affording additional structural and operating advantages.

In one embodiment, a trash can is disclosed comprising an exterior shell, a liner seated within the shell, a latch pivotably attached to the liner for securing a flexible bag to the liner, and a handle to facilitate placing and removing of the liner from the shell. It is an optional aspect of the invention to affix the handle of the liner to the latch. The liner of the trash can, in a featured embodiment, utilizes a latch having a body portion into which surplus of the flexible bag may be gathered and held.

In another embodiment, the trash can further comprises a lid connected to the exterior shell. It is an aspect of this embodiment to connect the lid to the shell comprising a front hinge, a back hinge and an actuating foot pedal. The front hinge preferably includes a first end attached via a pin member to the shell, a second end attached via a pin member to an interior surface of the lid, and a lever arm extending from the first end at an angle to form an “L”. The back hinge preferably includes a first end attached via a pin member to the shell proximate the front hinge attachment, and a second end attached via a pin member to an interior surface of the lid. The actuating foot pedal is preferably seated at a base of the exterior shell and connects to the lever arm of the front hinge such that depressing the foot pedal exerts a downward force on the lever arm to open the lid. In this configuration, the lid is lifted via a downward pull on the first hinge rather than a direct upward force on the lid.

Still another embodiment of the trash can comprises an exterior shell, a liner seated within the shell, and a spacer attached at a base of the shell for maintaining the trash can a distance from an adjacent object.

It is an aspect of the embodiment to provide a spacer which is retractable into the base of the shell. It is an optional aspect of the embodiment to provide a spacer which is adjustable in length.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an embodiment of the present step can in a closed condition;

FIG. 2 is a perspective view of the embodiment of FIG. 1 of the step can in an open condition;

FIG. 3 is a side view of an embodiment of the present step can illustrating one possible extended wall-spacer configuration;

FIG. 4 is a bottom view showing the wall-spacer of FIG. 3 partially extended;

FIG. 5 is a perspective view of an embodiment of a liner with bag latch in an open condition;

FIG. 6 is a side view of the liner of FIG. 5 showing the latch in a closed condition;

FIG. 7 is an exploded view of one embodiment of the trash step can assembly;

FIG. 8 illustrates an embodiment of the rod and foot pedal linkage for actuating the opening of the can lid;

FIG. 9 is a close up of an embodiment of the lid hinge connection points;

FIG. 10 is a close up of the open lid of FIG. 9; and

FIG. 11 is a cut away side view of the double hinge mechanism.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

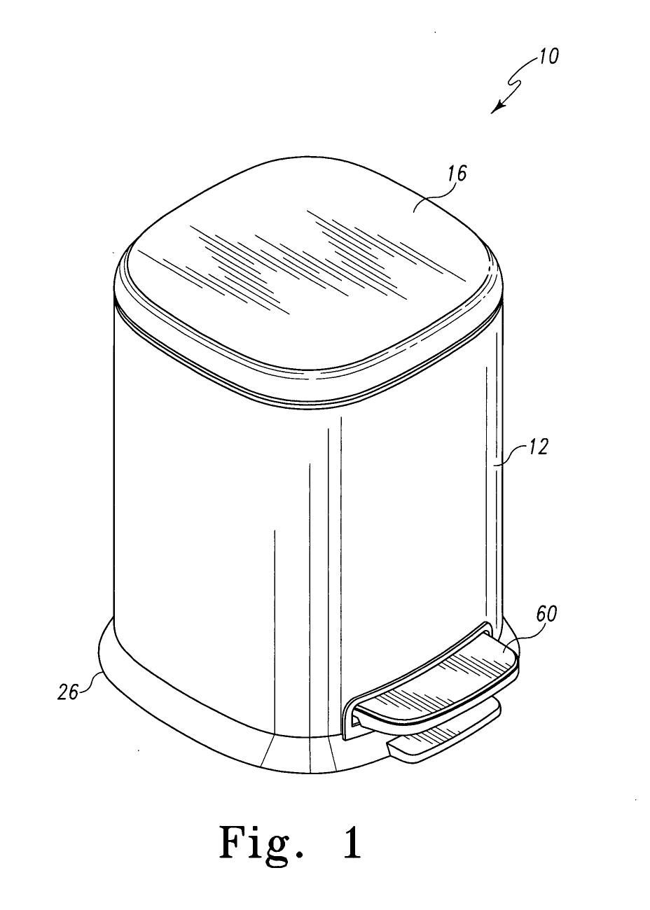

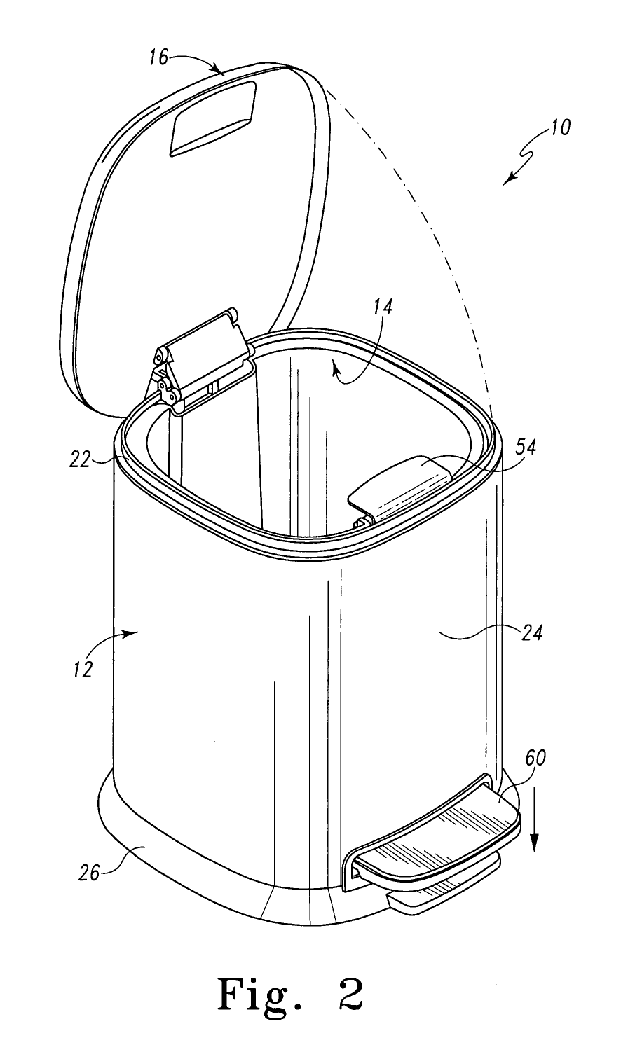

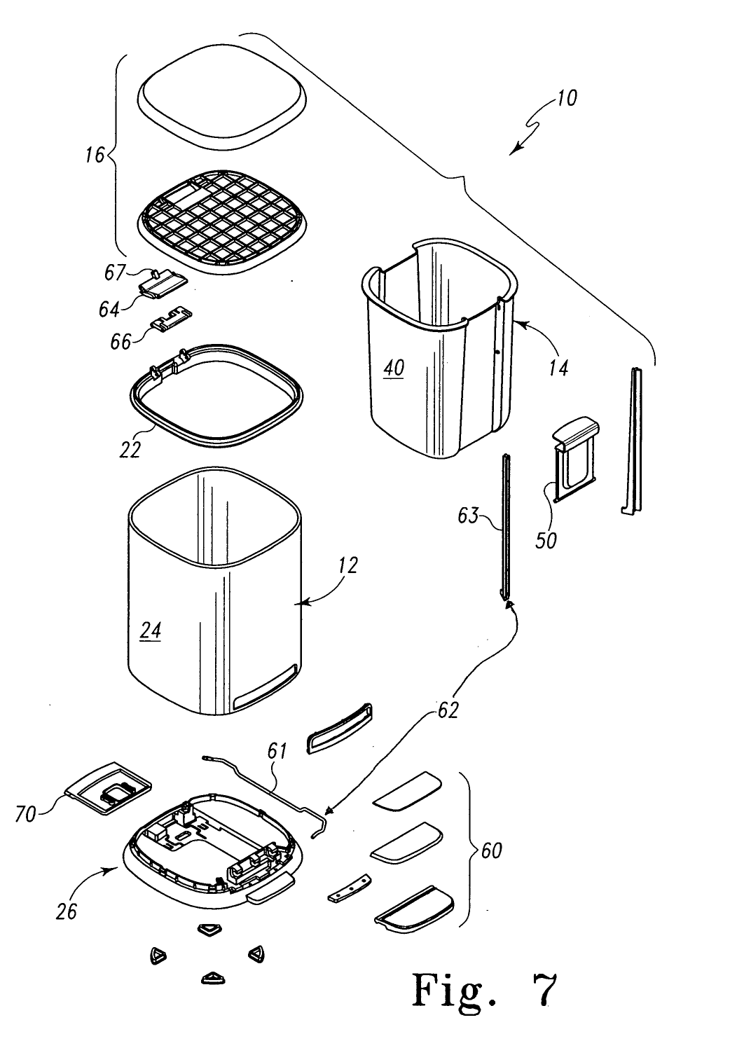

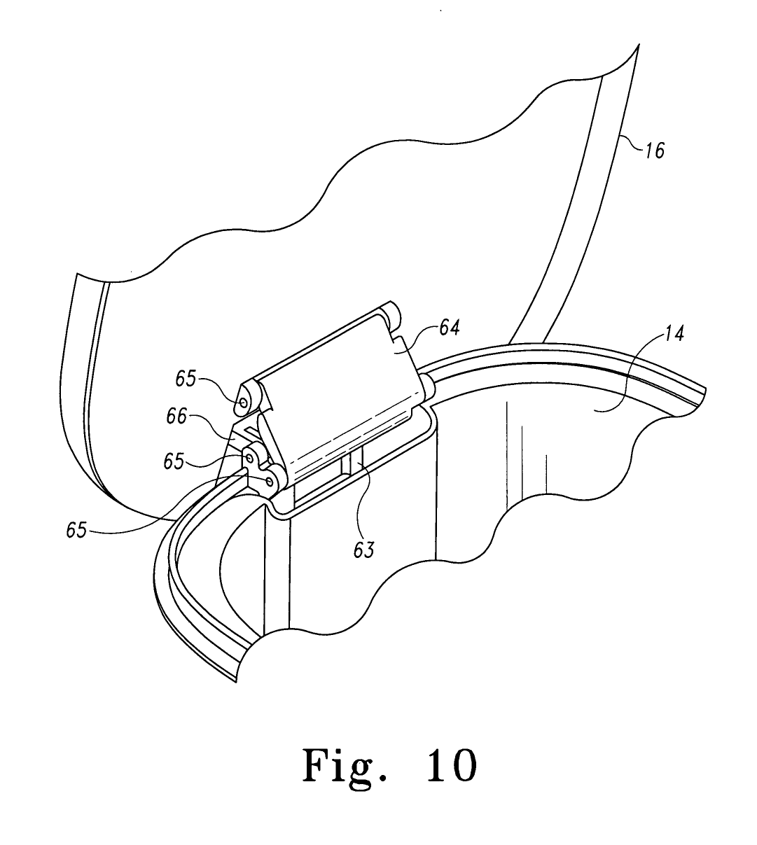

Referring to FIGS. 1-11, there is illustrated embodiments of a bathroom step can, generally designated by the numeral 10, and its several components. The step can 10 is comprised of an exterior shell 12, a liner 14 seated within the shell 12, and a lid 16 covering the open top of the shell 12. While the several features of the present device are described in connection with a trash step can, such as the type used in a kitchen or bathroom, it should be understood that such features may have applications to other types of trash cans as well. Such cans are not intended to be excluded from the scope of this application, except to the extent they are outside the bounds of the appended claims.

The exterior shell 12 is preferably a substantially rectangular or square cylinder with rounded corners, having an open top 20 defined by a rim 22, a sidewall 24 defining an interior space, and a base 26 closing off the bottom of the shell 12. Alternatively, the shell 12 may be a round or oval cylinder, or any other suitable, easy to manufacture shape. The base 26 may be flared as is known in the art for added stability, and it may be an integral or separate component from the shell 12. The shell 12, including the sidewall 24 and base 26, may be made of a number of different materials (e.g., plastic, metal, etc.), including any combinations of these known materials, and may present a decorative exterior for aesthetic purposes. The material and decorative features may dictate the preferred construction method of these components.

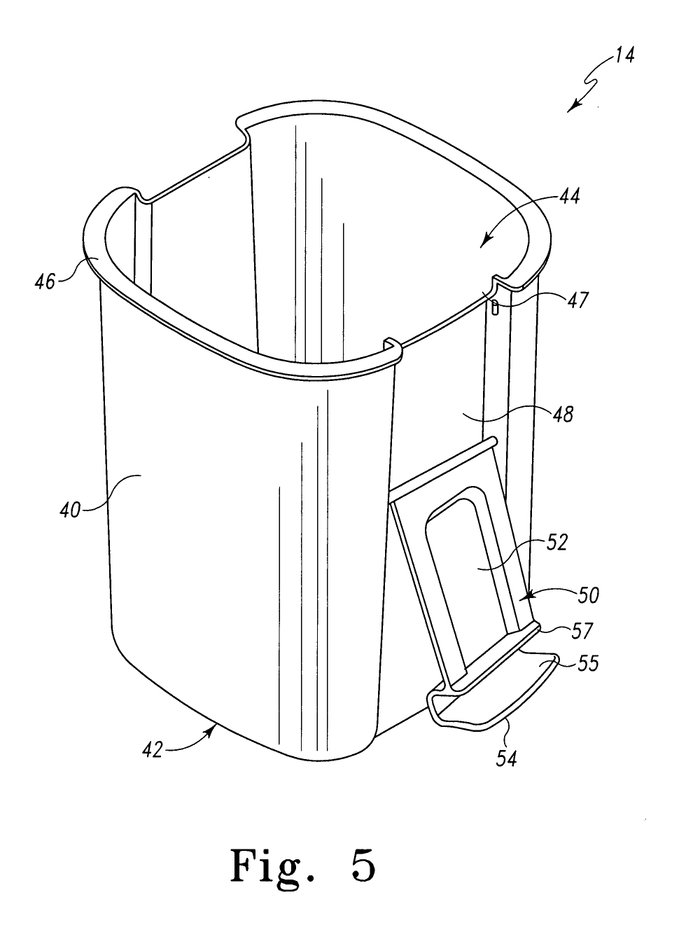

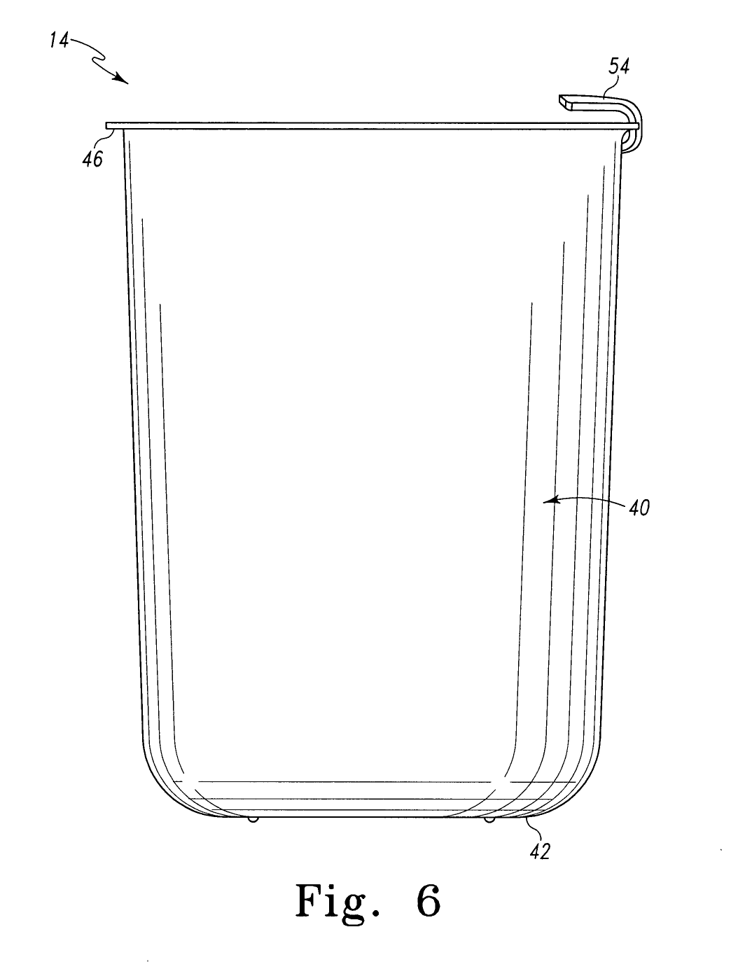

A preferred embodiment of the can liner 14 is illustrated in FIGS. 5-6. The liner 14 sits within the space of the shell 12 defined by the sidewall 24, and is comprised of a sidewall 40 adjoined to a bottom wall 42, which defines a second interior space 44. The liner 14 is preferably shaped similar to the exterior shell 12 in order to properly sit within the space of the shell. However, a flared rim 46 of the liner 14 abuts the rim 46 of the shell 12 to support the liner 14 within the shell 12. Naturally, the liner 14 may be made such that it sits on and is supported by the base 26 of the shell 12, or an alternative support structure (not shown) may be used within the shell 12 or on the liner 14 as desired.

The liner 14 comprises a hinged latch 50 attached at a front face 43 of the sidewall 40 within a recessed channel 48. The latch 50 is designed to achieve at least three functions. First, the latch 50 secures a flexible bag (not shown) to the liner 14. After a bag is placed into the liner 14, in a known manner, it is doubled over the liner rim 46. By moving the latch 50 into a closed position, as shown in FIG. 6, the bag is secured by virtue of being clamped between the liner rim 46 and the latch 50. The latch 50 engages the rim 22, specifically a top surface of the rim 22, in a friction or snap fit manner to be locked in place. By locking in place over the top of the rim 22, the present latch is sure to contact the flexible bag. Other means for actually locking the latch 50 in a closed position are certainly possible.

A second function of the latch 50 is to hide much of the excess flexible bag which is folded over the liner rim 46. The preferred latch 50 has a wide, channel-shaped body 52 to allow excess bag to be gathered within. This feature allows the flexible bag, which might otherwise just drape over the rim 22, to be pulled taut around the complete periphery of the liner opening. Again, by moving the latch 50 to the closed position, the gathered bag is secured between the latch body 52 and the liner sidewall 40 thereby holding the taut condition about the liner rim 46.

Finally, a third function of the latch 50 is to provide a handle which allows the liner 14 to be readily lifted from the space of the shell 12. Referring to FIG. 5, the latch 50 can be seen to have a C-shaped handle 54 affixed at the top of the body 52. The handle 54 preferably has a longer upper flange 55 to facilitate grasping by a user's hand. In the illustrated embodiment, the handle 54 is accommodated by the liner sidewall 40 by a small cut-out section 47 having a width to approximately match that of the handle 54. A channel 48 in the sidewall 40 of the liner 14 accommodates the body of the latch. The bottom flange 57 of the handle 54 may provide a friction or snap fit with the top edge of the cut-out section 47, as described above.

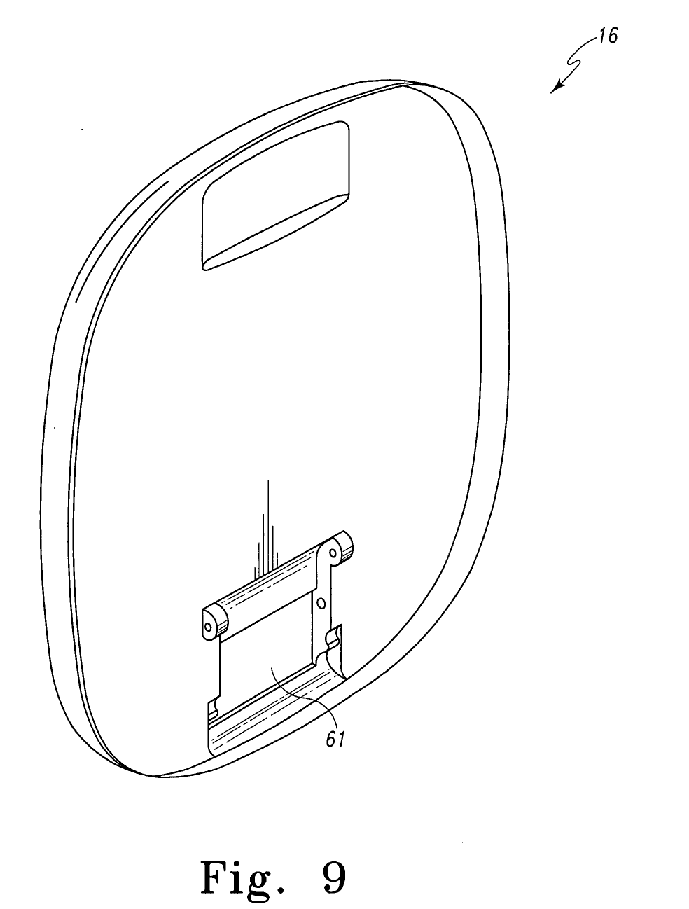

Referring now to FIGS. 9-11, another feature of the present invention can be more readily understood. Preferably, the step can 10 comprises a hinged lid 16 to cover the open top of the exterior shell 12 (and thus the seated liner 14, as well) and a foot pedal 60 proximate the base 26 of the exterior shell 12. The lid 16 and foot pedal 60 are connected via linkage 62 hidden against the shell sidewall 24 beneath the liner 14. Upon depressing the foot pedal 60, the lid 16 is actuated to an open position. Conversely, release of the foot pedal 60 results in the lid 16 returning to a closed position.

However, the lid 16 of the present invention preferably does not swing open from the rear edge of the lid like most prior art step can lids. Rather, through use of a unique double hinge mechanism connected at a distance from the rear edge, as shown in FIG. 9, the lid 16 is capable of opening wide with less swing. By allowing the back edge of the lid 16 to descend below the pivot points, the open height of the lid is also reduced.

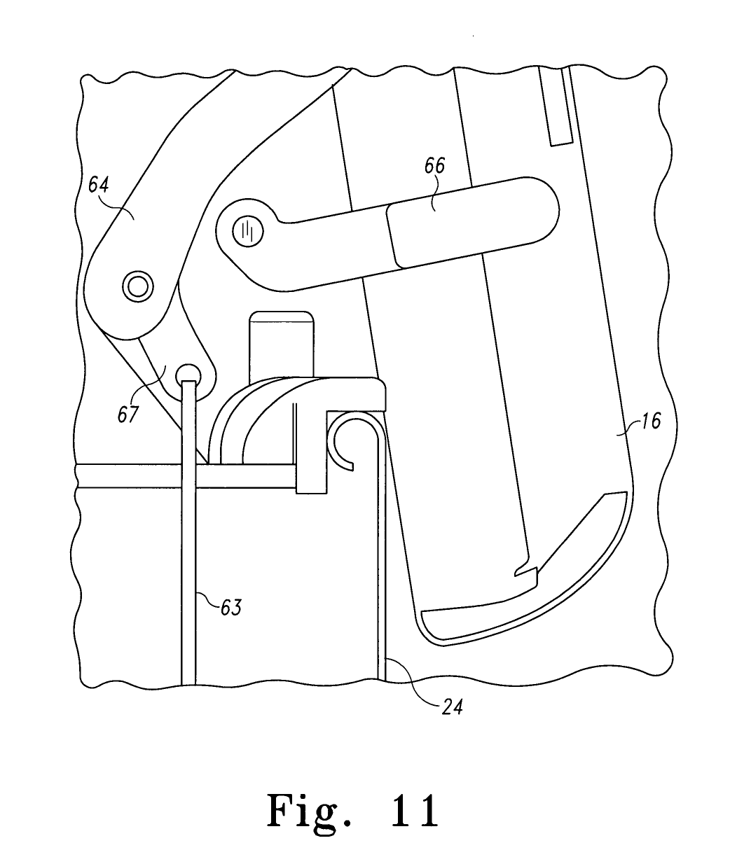

The double hinge mechanism consists of a front hinge 64 and a shorter back hinge 66. Each hinge is connected at a first end, via a pin member 65, to a flange 68 affixed to a rim 22 situated proximate the interior surface of, and preferably connected to, the shell 12. Each hinge is also separately attached at a second end, via a pin member 65, to the under surface of the lid 16. The front hinge 64 comprises a short lever arm 67, which extends at an angle, forming an “L” with the hinge body. Preferably, the lever arm 67 is integral to the hinge 64. To function properly, the pivot point of the front hinge 64—i.e., the point of connection to the rim of the shell 12—is located between the first end of the hinge 64 and the lever arm 67. The lever arm 67 connects the front hinge 64 to the linkage 62, as shown in FIG. 11. Operation of the opening mechanism is discussed in further detail below.

FIG. 9 shows the connection points on the lid 16 for the front and back hinges. A recess 61 in the underside of the lid 16 allows the lid 16 to lay flat against the rim 22 of the step can 10 by providing space for the back hinge 66 and front hinge 64 to reside in when the lid 16 is closed.

The hinged lid 16 is preferably operated manually in one of two ways. The first method is to simply pull up on a front portion of the lid 16, raising it to an open position. Alternatively, the lid 16 may be opened using foot pedal 60.

The foot pedal 60 is positioned to extend, like that of most step cans, from a point along the base of the can 10. The foot pedal 60 should extend a substantial distance from the shell sidewall 24 to facilitate actuation by the users foot. The extended portion of the pedal 60 may be any desired shape which accomplishes the actuating function described.

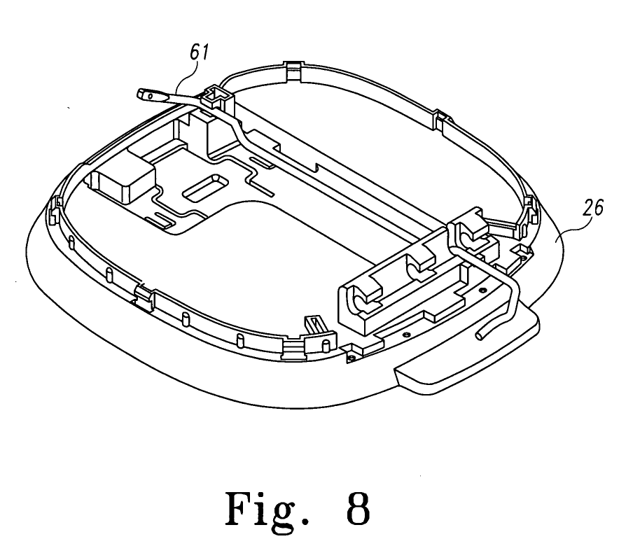

The linkage 62 which connects the foot pedal 60 to the front hinge 64 is comprised of a horizontal crank rod 61 and a vertical pull rod 63. The crank rod 61 is seated within the shell base 26, as shown in FIG. 8, with one end contacting the food pedal 60. The other end of the crank rod 61 intersects with one end of the pull rod 63. The opposing end of the pull rod 63 connects to the lever arm 67 of the front hinge 64. The linkage 62 is preferably concealed between the shell 12 and the liner 14 of the step can 10. A channel 52 within the liner 14 accommodates the linkage 62, particularly the pull rod 63, as it runs from the base 26 to the lid 16.

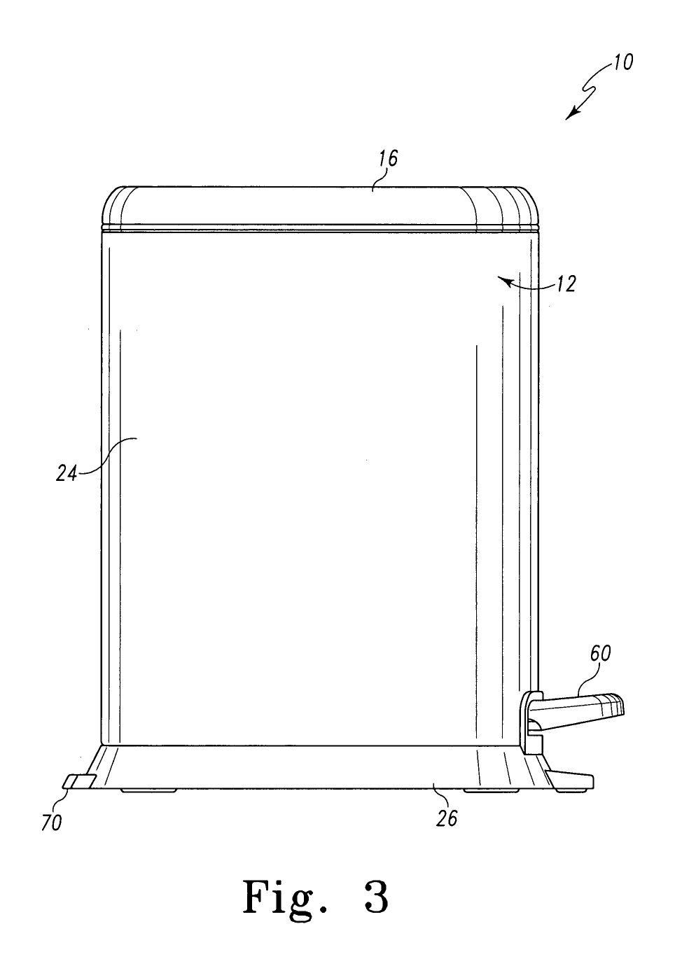

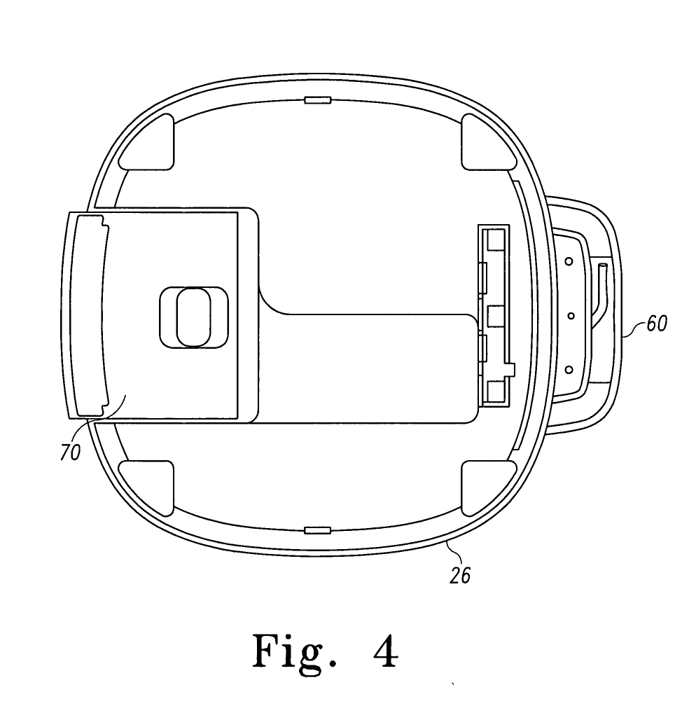

One additional feature of an embodiment of the present invention is provided by spacer 70. The spacer, as shown in FIGS. 3 and 4, retains the step can 10 at a distance from an adjacent object or surface. Preferably, the spacer 70 is slidably extendable from the rear of the base 26 of the shell 12. The position of the spacer 70 is designed to coincide with the space to be occupied by the opened lid 16. In this manner, the spacer 70 prevents the step can 10 from being positioned too close to an object or surface such that repeated banging of the lid 16 against the object or surface or obstruction of the lid 16 by the object or surface is prevented.

The spacer 70 may extend either a set distance, variably in a telescoping manner, or variably in an indexed manner using detents or other similar indexing mechanisms. Whether set or variably extendable, the spacer 70 might be capable of extending a distance in the range of about one to eight inches, preferably about two to six inches, and most preferably about four inches. When not extended, the spacer 70 retracts into the base 26 of the shell 12 until needed. While best suited for operation from the shell base 26 in many uses, it should be understood that an embodiment of the spacer 70, such as for example, a rod (not shown), may be attached to and extend from any suitable component of the step can 10.

In typically use, the step can 10 would be positioned in an area such as, for example, a kitchen. The spacer 70 would be extended either fully or, for example, a distance of a couple inches and placed adjacent a wall such that the spacer 70 contacts the wall and the foot pedal 60 is most accessible.

To line the step can 10, the lid 16 may be moved to its open position by either lifting by hand or depressing the foot pedal 60. If the foot pedal 60 is depressed, it turns the horizontal crank rod 61 such that the second end of the crank rod 61 pulls downward on the pull rod 63. The pull rod 63 in turn acts downward on the lever arm 67 of the front hinge 64, rotating the second end of the front hinge 64 to push upward on the lid 16 at the connection point. As the lid 16 is opened, the back hinge 66 guides the rear edge of the lid to the rear (i.e., toward the wall) and downward, while the front hinge 64 directs the remainder of the lid 16 upward and back. Together, the two hinges operate to open the lid 16 and provide access to the interior of the step can 10.

At this point, the liner 14 may be removed from the step can 10 by grasping the handle 54 of the latch 50 and lifting the liner 14 straight up from the interior space of the shell 12. The latch 50 can then be moved to a down position. When a flexible bag is properly seated within the liner 14, the excess bag is folded down the liner sidewall 40 and gathered within the channel 48. The latch 50 can then be rotated back to the upward position to secure the excess bag within the latch body 50 as well as secure the bag at the rim of the liner 14. The liner 14, with flexible bag in place, can then be lifted by the handle 54 and returned to the interior space of the shell 12. The lid 16 can then be closed over the seated liner 14.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A trash can comprising:
a. an exterior shell comprised of a wall defining a space;
b. a liner seated within the space of the shell and comprised of a sidewall having a rim and adjoined to a bottom wall to define an interior space;
c. a latch attached to the liner for securing a flexible bag to the liner when placed within the interior space; and
d. a handle connected to the liner to facilitate placing and removing the liner from the exterior shell space.

2. The trash can of claim 1, wherein the handle is affixed to the latch.

3. The trash can of claim 1, wherein the latch is pivotably attached to the sidewall of the liner.

4. The trash can of claim 3, wherein the handle is affixed to the latch.

5. The trash can of claim 1, wherein the latch comprises a body portion into which surplus of the flexible bag may be gathered and held.

6. The trash can of claim 5, further comprising a lid connected to the exterior shell.

7. The trash can of claim 6, wherein the lid is hinged to the shell comprising:
a. a front hinge comprising:
i. a first end attached via a pin member to the shell;
ii. a second end attached via a pin member to an interior surface of the lid; and
iii. a lever arm extending from the first end at an angle to form an “L”;
b. a back hinge comprising:
i. a first end attached via a pin member to the shell proximate the front hinge attachment; and
ii. a second end attached via a pin member to an interior surface of the lid;
c. a foot pedal seated at a base of the exterior shell and connected to the lever arm of the front hinge such that depressing the foot pedal exerts a downward force on the lever arm to open the lid.

8. The trash can of claim 7, wherein the front hinge is attached such that the downward force on the lever arm pushes the second end of the front hinge upward on the interior surface of the lid to open the lid.

9. The trash can of claim 7, wherein the back hinge is shorter in length than the front hinge.

10. The trash can of claim 8, wherein the front hinge and back hinge are attached to the interior surface of the lid a distance from an edge.

11. The trash can of claim 1, further comprising a spacer attached to the shell for maintaining the trash can a distance from an adjacent object.

12. The trash can of claim 11, wherein the spacer is retractable.

13. The trash can of claim 11, wherein the spacer is adjustable in length.

14. The trash can of claim 7, further comprising a spacer attached to the shell opposite the foot pedal for maintaining the trash can a distance from an adjacent object.

15. The trash can of claim 14, wherein the spacer is retractable.

16. The trash can of claim 14, wherein the spacer is adjustable in length.

17. The trash can of claim 1, wherein the latch secures the bag at the rim of the liner.

18. The trash can of claim 17, wherein the latch engages the rim of the liner to lock into a closed position.

19. The trash can of claim 2, wherein the latch engages a top surface of the rim of the liner to lock into a closed position.

20. The trash can of claim 1, wherein the latch retains the flexible bag in a taut condition about the rim of the liner as it conceals excess bag material.

21. A trash can liner comprising:
a. a sidewall adjoined to a bottom wall to define an interior space; and
b. a latch attached to the sidewall for securing a flexible bag to the liner when placed within the interior space.

22. The trash can liner of claim 21, wherein the latch is pivotably attached to the sidewall such that it is capable of moving between an open, downward position to a closed, upward position.

23. The trash can liner of claim 21, further comprising a handle to facilitate lifting and carrying of the liner.

24. The trash can liner of claim 23, wherein the handle is affixed to the latch.

25. The trash can liner of claim 21, wherein the latch is pivotably attached to the sidewall of the liner.

26. The trash can liner of claim 24, wherein the latch comprises a body having first and second ends and the handle is affixed to the first end and the second end is hinged to the sidewall.

27. The trash can liner of claim 26, further comprising a rim along a top edge of the sidewall, and wherein the handle snap fits to the rim.

28. The trash can liner of claim 26, wherein the body of the latch includes a cavity into which surplus of the flexible bag may be gathered and held.

29. A trash can comprising:
a. an exterior shell comprised of a base and a peripheral wall defining a space;
b. a liner seated within the space of the shell and comprised of a sidewall adjoined to a bottom wall to define an interior space; and
c. a spacer attached to the shell for maintaining the trash can a distance from an adjacent object.

30. The trash can of claim 29, wherein the spacer is retractable into the base of the shell.

31. The trash can of claim 29, wherein the spacer is adjustable in length.

32. The trash can of claim 29, further comprising a lid connected to the exterior shell.

33. The trash can of claim 32, wherein the lid is hinged to the shell comprising:
a. a front hinge comprising:
i. a first end attached via a pin member to the shell;
ii. a second end attached via a pin member to an interior surface of the lid; and
iii. a lever arm extending from the first end at an angle to form an “L”;
b. a back hinge comprising:
i. a first end attached via a pin member to the shell proximate the front hinge attachment; and
ii. a second end attached via a pin member to an interior surface of the lid;
c. a foot pedal seated at a base of the exterior shell and connected to the lever arm of the front hinge such that depressing the foot pedal exerts a downward force on the lever arm to open the lid.

34. The trash can of claim 33, wherein the front hinge is attached such that the downward force on the lever arm pushes the second end of the front hinge upward on the interior surface of the lid to open the lid.

35. The trash can of claim 33, wherein the back hinge is shorter in length than the front hinge.

36. The trash can of claim 34, wherein the front hinge and back hinge are attached to the interior surface of the lid a distance from an edge.
